(19) United States
(12) Patent Application Publication
(10) Pub. No.: US 2003/0154746 A1
(43) Pub. Date: Aug. 21, 2003

(54) Method for bending a glass sheet and a bending mould

(76) Inventors: Esa Lammi, Kangasala (FI); Petri Lammi, Tampere (FI); Kari Vaha-Antila, Nokia (FI)

Correspondence Address: LARSON & TAYLOR, PLC, 1199 NORTH FAIRFAX STREET, SUITE 900, ALEXANDRIA, VA, 22314, US

(21) Appl. No.: 10/332,467

(22) PCT Filed: Jul. 10, 2001
(86) PCT No.: PCT/FI01/00656

(30) Foreign Application Priority Data
Jul. 10, 2000 (FI) 20001634

(51) Int. Cl. C03B 23/025

(52) U.S. Cl. 65/107; 65/273; 65/289

(57) ABSTRACT

A method for bending a glass sheet (1) in a glass bending furnace utilizing gravity and a bending mould, whereby the glass sheet is put onto the mould and heated into bending temperature to make the glass bend into a wanted shape by means of the mould. The glass sheet (1) is supported by means of the mould adjustable middle component (6), by means of which bearing impact the glass sheet is supported and its getting down onto mould support (4) regulated and which beating element, when let down, forms a part of the mould.

This invention relates to a method and to a mould utilizing the method for bending a glass sheet in a glass bending furnace using gravity and the bending mould, whereby the glass sheet is put onto the mould and heated into bending temperature to make the glass bend into a wanted shape by means of the mould.

Previously known are glass bending moulds, which are put into the bending furnace and furnished with supports to determine the final shape of the glass during bending. As a method is known that a mould formed by supports is in its initial state a top plane, onto which the glass is mounted, as presented in U.S. Pat. No. 4,957,531, where the mould can, for instance by means of actuators, be changed into a wanted curvature for the final form of the glass. The glass sheet to be bent can be even big if at the start the mould is flat and supporting the glass sheet from underneath.

In a construction as above the mould becomes complicated, since each support tube must be furnished with an individual actuator to move the tubes towards the final shape of the mould with the glass sheet in bending temperature.

Known is the use of an annular, so called ring mould, where the glass sheet is supported from its edges only, while the middle section remains without support. Already, even with smaller glass sheets, some bending takes place on the spherical surface. By bending quite big, thin windshields, the use of intermediate support in the middle of the glass long sides close to the opposite edges is known, for instance, from patent publications FI-B-105676. FI-C-69446 or U.S. Pat. No. 3,023,542. In these the prime target is to prevent the glass sheet from breaking during the preheating. Even in these cases the glass bends from its centre to the spherical surface, which is even required, when it is the question of windshields. Especially in the architectural section cylindrical shapes are wanted, so that by means of the above solutions the required result is not achieved.

Known from patent publication FI-80870 is a mould surface formed of tubes giving the glass a cylindrical bending shape. The problem in this case is the glass coming down at first from the middle section, whereby, while waiting for the bending of the edge sections to be, completed, marks are printed into the soft glass in the middle section. Another problem especially with great bending angles, over ⅛-circle, is the asymmetric sliding of opposite sides during glass bending.

In order to solve the above presented disadvantages and problems a new bending method and mould was developed, by means of which an improvement of the previous level of technique is achieved and existed problems are prevented. The invention is characterized in what is presented in the claims.

The advantage of the invention is that already in the initial state the glass sheet is supported by means of the mould and its elevated portion also from its middle section beside the edges. Essential is that the support of edges, but also of the middle section, takes place continuously throughout the cylindrical or substantially cylindrical length of bending. This enables bending of one glass sheet of maximum length or many shorter glass sheets simultaneously lengthways in the cylinder direction without any changes or regulating measures in the mould or the glass sheet support, at the same time preventing bending of the glass sheet or glass sheets to spherical surface, when not wanted. The mould middle component, i.e. the support of glass sheet middle section, can be let down and controlled along with bending so that the required contact power against the glass sheet remains throughout the process and the supporting power being formed sideways gets during bending a symmetric slide on the mould. In preventing too fast bending of the middle section, sufficient time for heating the edge sections is achieved, due to which the glass sheet arrives at the mould substantially simultaneously with its whole area and of marks on the glass are prevented. The invention is also characterized in that the glass supporting adjustable components of the middle section form at the final phase of bending a part of the mould surface that produces the final shape of the glass sheet. Adjustment of mould middle component during the process can either be controlled manually or using data measured as regulating parameter from some physical variable associated with bending.

In the following the invention is disclosed with reference to the enclosed drawing, where

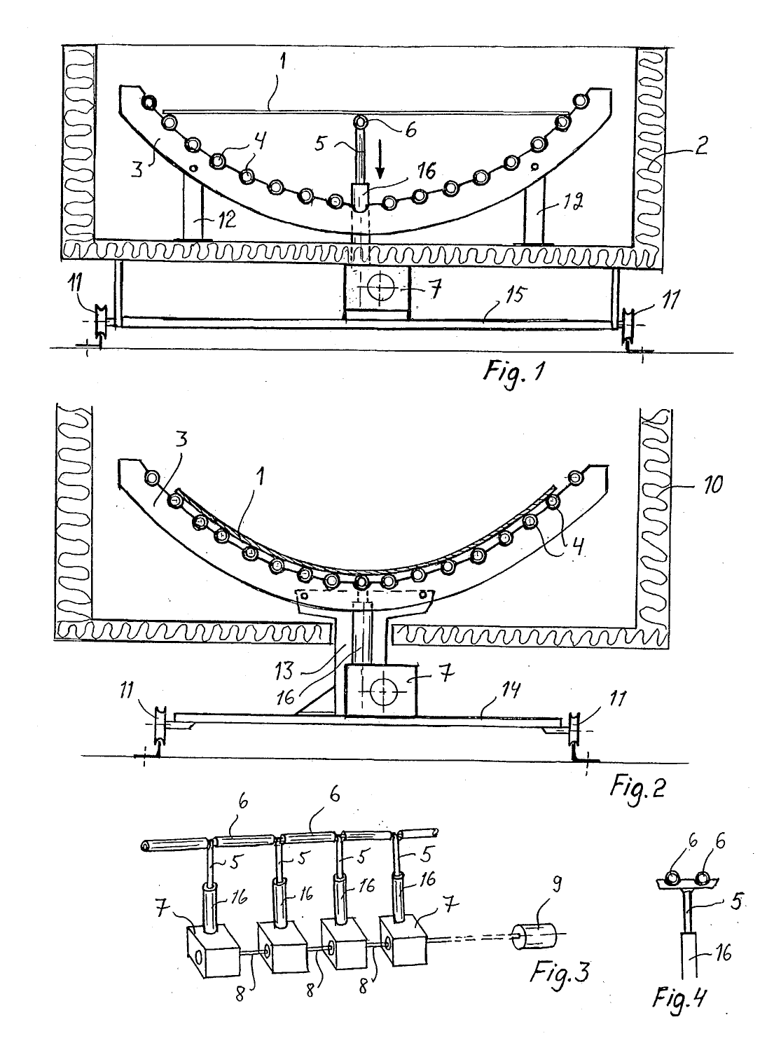

FIG. 1 shows a mould carriage transportable in a glass bending furnace as per this invention viewed from one end.

FIG. 2 shows a glass bending furnace and a mould carriage being transported out from it viewed from one end.

FIG. 3 Shows a movable mould part and its lifting mechanics.

FIG. 4 Shows a movable mould part as a construction of dual support.

FIG. 1 shows a mould carriage for glass bending, transportable in a glass bending furnace, furnished with heat insulated walls 2 and a lower frame 15 with wheels 11. The carriage has a mould determining the glass bending shape that is formed by curved shaping strips 3 with gaps for supporting tubes 4. Shaping strips 3 can be easily changed for different bending shapes. The glass sheet to be bent is placed into the mould as shown in the figure, whereby it is supported only from its two edges by the mould. Support 6 formed by a part of the mould as per this invention is placed on the mould centre line. Finally, in this case component 6 forms the lowest mould supporting element. The movable bearing middle component 6 is similar to the other mould supporting elements 4. There can be similar supporting elements side by side, as illustrated in FIG. 4. In the shaping strips 3 there are corresponding gaps for these as for other supporting elements 4. Mould component 6, which can be lifted up and let down during bending, supports the glass sheet also from the middle section.

Into the mould carriage a mechanical lifting-and letting down function is arranged by a motor 9, gears 7, auxiliary shaft 8 and lifting arms 5 and 16 as shown in FIG. 3. The lifting an getting down mechanics run along with the mould carriage. By means of the adjusting system the letting down of the bearing middle component/components is begun only when the glass starts to bend significantly.

In FIG. 2 the glass sheet is in bent shape in the mould and then movable mould component 6 has already also done its supporting and come down to its place as a part of the mould. FIG. 2 shows a mould carriage construction that can be moved into furnace 10 for the time of heating and bending, whereby mainly only supports 4 and 6 and the shaping curves 3 are in the furnace. Shaping curves 3 are fixed to the carriage frame 14 by means of support 13. The arm system 5,16 that moves the bearing middle component 6 and support 13 move in a travel hole on the furnace bottom

The glass tendency to bend is found out measuring the glass temperature in the furnace. According to temperature the letting-down mechanics of the mould middle component 6 is by means of an adjusting device in the equipment steered to let down the mould middle component 6 properly to the lowest point during bending, thus the shaping curves 3 then determine the curvature the glass will become. The temperature reached, at which the mould middle component is let down, can be determined by experiment.

Another possibility to adjust the lifting and letting-down mechanism of the mould middle component is to install load measuring sensors, such as levellers, into the structures of supports 5,7,16, in mould middle component 6, whereby the load caused by the glass sheet on mould 6 can be measured. Increase of load is a sign that the glass has started to bend. Then letting down the adjustable mould middle component gets started, so that it won't support the glass too much and does not cause any faults in the curvature.

The downward path of the adjustable mould middle component 6 is most suitably straight down in the glass bending direction. So the adjustable middle component 6 remains throughout bending in contact on the same spot with the glass. The adjustable middle component then steers and improves glass supporting on the mould and prevents possible glass motions sidewise during bending. Sidewise steering facilitates the controlled letting-down especially of a diamond-shaped glass onto the mould. As another harmful glass motion occurred by bending has been the glass edge falling off the support, whereby the glass gets asymmetrically into the mould or the glass edge falls only in one end of the mould off the support, whereby the glass turns a little crosswise in the mould ending in a cylinder form distorted by bending.

FIG. 3 shows a solution for moving the adjustable middle component 6 of the multielement mould by means of motor 9, gears 7 and auxiliary shaft 8. For instance, a wormgear reducer can be used gear 7. The motor rotation is regulated by an adjusting device. The adjusting device receives data, for instance, of the glass temperature as pyrometer measuring or data from a power sensor, located in the supports 5,16 of bearing element 6 or in the supports of gears 7 regarding load caused by the glass, and it adjusts motor 9 to. let down the mould middle component 6 according to a preprogrammed adjusting program. The downward motion of bearing element 6 can be controlled by standard speed or using different gears and different speeds in them. In the embodiment as per this invention no separate locking mechanism is required, which would be released on arriving in the bending chamber, while the locking mechanism is self-retaining.

Shaping strips 3 producing different curvatures can be exchanged, in the mould and one and the same supporting construction 5,6, 7,16 can be used in connection with them. The required path and initial status of bearing component 6 must be taken into account in different cases, when programming the bearing element motion.

1. A method for bending a glass sheet (1) in a glass bending furnace utilizing gravity and a bending mould, whereby the glass sheet is put on the mould and heated into bending temperature in order to make the glass bend into a wanted shape by means of the mould, wherein the unbent glass sheet (1) is supported from the glass edges by means of mould supports (4) locating under said glass edges wherein the other mould supports (4) are locating in the final mould position, characterized in that said unbent glass sheet (1) is further supported from the glass (1) sheet middle section by means of mould middle component (6) and that during glass bending said adjustable middle component (6) of said mould is let down in order to get the glass sheet down on the mould supports, and that said middle component (6), let down by the method, forms a part of the final mould.

2. A method according to claim 1 characterized in that during glass bending the mould middle component (6) is let down in order to reduce its supporting effect and to get the glass down on the mould using the temperature measured as adjusting parameter from the glass (1).

3. A method according to claim 1 characterized in that during glass bending the mould middle component (6) is let down in order to reduce its supporting effect and to get the glass down on the mould using the load caused by the glass and measured as adjusting parameter from the bearing middle component.

4. A method according to claim 1 characterized in that as downward path for the mould middle component contact part (6) the same path is arranged as the downward path of the corresponding contact part of the glass during bending.

5. A bending mould to be placed in a glass bending furnace, said bending mould having a plurality of supporting elements (4) resting on which a glass sheet (1) is meant to sink by gravity into a wanted shape, when said glass sheet has reached its bending temperature, in which mould the unbent glass sheet (1) is supported from the glass edges by means of mould supports (4) locating under said glass edges wherein the other mould supports (4) are locating in the final mould position, characterized in that the mould comprises
The glass sheet (1) during the whole bending process supporting adjustable middle component (6), for which a path has been arranged in the glass bending direction and which is in the final stage of glass bending let down to its place in order to form a part of the bending mould, and
Installed in the mould carriage, a mechanism (7,9) carrying out motion for said mould middle component and steered according to information measured either from glass sheet (1) or its impact.

6. A bending mould according to claim 5 characterized in that there is one or more bearing components (6) side by side or one after another and located on the line of the substantially lowest spot in the mould.

7. A bending mould according to claim 5 characterized in that with regard to their construction the bearing components (6) of the adjustable mould part are equal to the other support elements (4).
